(19) United States
(12) Patent Application Publication
(10) Pub. No.: US 2025/0241240 A1
(43) Pub. Date: Jul. 31, 2025

(54) METHOD FOR MONITORING A CROP FLOW, AND HARVESTING MACHINE

(71) Applicant: SMF-HOLDING GMBH, Eichelhardt (DE)

(72) Inventor: Steffen GÜRKE, Ruppichteroth (DE)

(73) Assignee: SMF-HOLDING GMBH, Eichelhardt (DE)

(21) Appl. No.: 18/854,249

(22) PCT Filed: Mar. 30, 2023
(86) PCT No.: PCT/EP2023/058310

§ 371 Date: Oct. 4, 2024

(30) Foreign Application Priority Data
Apr. 5, 2022 (DE) 10 2022 108 190.7

(51) Int. Cl. A01D 41/127

(52) U.S. Cl. CPC A01D 41/1271

(57) ABSTRACT

Method for monitoring a crop flow in a conveyor device for crop material of a harvesting machine and harvesting machine with a conveyor device for crop material and with a device for monitoring a crop flow in the conveyor device.

### CROSS REFERENCE TO RELATED APPLICATIONS

This is a National Stage Application of International Application No. PCT/EP2023/058310 filed Mar. 30, 2023, claiming priority based on German Patent Application No. 10 2022 108 190.7 filed Apr. 5, 2022.

### BACKGROUND OF THE INVENTION

### Field

The application relates to a method for monitoring a crop flow in a conveyor device for crop material of a harvesting machine and a harvesting machine.

### Background

In combine harvesting, an even crop material intake is the basis for an even crop flow in the threshing units and thus for optimum utilization of the harvesting machine.

EP 3 714 674 A1 describes a system and a method for controlling a combine harvester. The method comprises the steps of receiving grain flow sensor signals from a plurality of grain flow sensors, determining a current load on a shaker section based on the received grain flow sensor signals, and adjusting an aggressiveness setting of a threshing and separating section of the combine harvester based on the current load. The grain flow sensors are provided under and next to a crop transfer surface of the shaker section of the combine harvester and are distributed over a length of the shaker section.

Short-term changes in harvesting conditions in the field as well as foreign objects or soil picked up by the cutting device can disrupt the crop flow. In combine harvesting, observation of the crop flow by the machine operator is the most common method for detecting crop flow disturbances in the cutting device. The trend towards ever wider working widths and ever higher forward speeds makes this task more difficult for the driver.

One task can be to improve the monitoring of the crop flow.

The problem is solved by a method and a harvesting machine. Embodiments are described in the sub-claims.

### SUMMARY OF THE INVENTION

In the method for monitoring a crop flow in a conveyor device for crop material of a harvesting machine, an electrical or dielectric conductivity of the crop flow of the conveyed crop material is measured with at least one conductivity sensor in the conveyor device and a signal representing the measured conductivity is generated. The signal is analyzed with an evaluation device, wherein the crop flow is evaluated on the basis of a development of at least one of the following properties of the signal: Noise frequency, noise amplitude and base signal. The base signal corresponds to an average electrical conductivity of the crop flow. The currently measured conductivity varies greatly due to the movement, which is referred to as noise. Noise amplitude and noise frequency also vary within certain limits. A change in noise amplitude and noise frequency within the meaning of the application is given as soon as a predetermined threshold value of the change is reached.

The method of monitoring the crop flow allows automatic detection of crop flow disturbances and offers the following benefits. On the one hand, the operator of the harvesting machine is relieved, as he does not have to constantly concentrate on monitoring the crop flow across the entire working width in difficult harvesting conditions. This increases comfort and counteracts driver fatigue. On the other hand, the early detection of crop flow disturbances makes it possible to counteract the disturbances. In the case of soil accumulations, for example, the cutting height can be adjusted at short notice to prevent the crop material from building up and to allow the accumulation to subside. Crop flow disturbances are detected earlier and are smaller. Ultimately, the downtime of the harvesting machine is reduced. Recognizing pulsating crop flow by varying the straw length makes it possible to automatically adjust the length of the cutting table in so-called Vario cutting devices. This ensures a more even crop flow and better machine utilization.

According to one embodiment, the following sensors can be used to detect crop flow disturbances. The working width of the cutting device is divided into segments. Each segment is monitored by a sensor system. All signals from the sensors in the segments are fed to a central evaluation unit and analyzed. For example, conductivity sensors are used as sensors, which are in contact with the material flow. The cutting table is suitable for positioning the sensors, allowing the material flow to be guided over the sensors. The conductivity sensors can be based on methods for measuring electrical conductivity, dielectric conductivity or capacitive conductivity.

The conductivity of the crop material is largely determined by its water content. The electrical conductivity and dielectric constant of water is significantly higher than that of dry biomass. Furthermore, the measurement of conductivity is also influenced by the density of the material to be measured and the distance of the material to the sensor or the contact to the sensor. Changes in the density of the material are in turn determined by the amount of crop material and the compression of the crop material. Density and sensor contact change with high dynamics in the crop flow. It is to be expected that the signal of a conductivity sensor is made up of a base signal level and a noise component.

According to a further embodiment, a reduction in the noise frequency indicates a reduced flow rate of the crop flow.

According to a further embodiment, a reduction in the noise amplitude with a simultaneous increase in the base signal indicates a higher water content in the crop flow, whereby an accumulation of soil in the conveyor device is indicated in particular when a limit value of the reduction in the noise amplitude and/or the increase in the base signal is reached.

According to a further embodiment, the conductivity of the crop flow of the conveyed crop material is measured with a plurality of conductivity sensors spaced apart from one another, wherein a signal representing the measured conductivity is generated for each conductivity sensor and wherein the signals are analyzed with the evaluation device and compared with one another.

According to a further embodiment, a first part of the plurality of conductivity sensors is arranged on the conveyor device and a second part of the plurality of conductivity sensors is arranged on other crop material processing and/or conveying components of the harvesting machine.

According to a further embodiment, a deviation of at least one of the properties noise frequency, noise amplitude and base signal of a first signal from at least two second signals indicates an irregularity of the crop flow in the area of the sensor that generates the first signal.

According to a further embodiment, at least one throughput signal that characterizes a throughput of crop material by the conveyor device, such as a driving speed of the harvesting machine or a cutting power, is taken into account in the analysis of the at least one signal.

According to a further embodiment, a conductivity of the crop flow of the conveyed crop material is measured with a multidimensional array of conductivity sensors in the conveyor device, wherein in particular a recording of a signal of the conductivity sensor at a first measuring point is compared with the respective signal of the conductivity sensor at one or more second measuring points, and wherein a direction and/or a velocity of the crop flow between the first measuring point and the second measuring point is determined if the recording matches the signal of the conductivity sensor of one of the second measuring points.

According to a further embodiment, the speed of the crop flow between the first measuring point and the second measuring point is determined by relating a distance between the first measuring point and the second measuring point to a time between the recording at the first measuring point and the detection of the recording at the second measuring point.

The harvesting machine with a conveyor device for crop material and with a device for monitoring a crop flow in the conveyor device, with which the task is solved, has at least one conductivity sensor for generating a signal, which represents a conductivity of a crop flow of the conveyed crop material, on the conveyor device, the device for monitoring the crop flow having an evaluation device for analyzing the signal.

According to one embodiment, it is provided that the conveyor device is associated with a cutting device of the harvesting machine, wherein the conveyor device has a cutting table and wherein the at least one conductivity sensor is arranged on the cutting table. In particular, the conductivity sensor can be arranged on a fall-back edge or restraining device of the cutting table.

According to one embodiment, it is provided that the restraining device has an extension, wherein the extension is arranged approximately parallel to a surface of the cutting table, and wherein the conductivity sensor is arranged on the extension.

According to one embodiment, it is provided that a plurality of conductivity sensors are arranged on the cutting table, wherein the conductivity sensors are spaced apart from one another, wherein each of the conductivity sensors generates a signal representing the conductivity of the crop flow, and wherein the evaluation device compares the signals with one another. At least some of the conductivity sensors can be distributed along the width of the cutting device. At least some of the conductivity sensors can be distributed along a conveying direction of the crop flow through the conveyor device.

Alternatively, the conveyor device can, for example, be assigned to a separator device of the harvesting machine. At least one conductivity sensor can be arranged in a separator rotor, and at least one further conductivity sensor can be arranged downstream of the separator rotor, at the inlet to a straw chopper. If crop material accumulates in the straw chopper, the evaluation device detects this according to the method described above via the changed noise behavior of the second conductivity sensor. A crop flow disturbances is detected and an advantageous response can be made before the separator rotor also becomes blocked. Monitoring using conductivity sensors has the advantage of being fast and sensitive.

### BRIEF DESCRIPTION OF THE DRAWINGS

The method and the harvesting machine are explained below with reference to the accompanying drawings, wherein features of the method are also applicable mutatis mutandis to the harvesting machine and wherein features of the harvesting machine are also applicable mutatis mutandis to the method.

FIG. 1 shows a schematic representation of an embodiment of a harvesting machine according to the invention.

FIG. 2 shows a conveyor device with a conductivity sensor of the harvesting machine according to FIG. 1 in a sectional view;

FIG. 3 shows a recorded signal from a conductivity sensor in a diagram;

FIGS. 4 and 5 show diagrams explaining a conductivity measurement of a crop flow in the conveyor device.

### DETAILED DESCRIPTION OF THE INVENTION

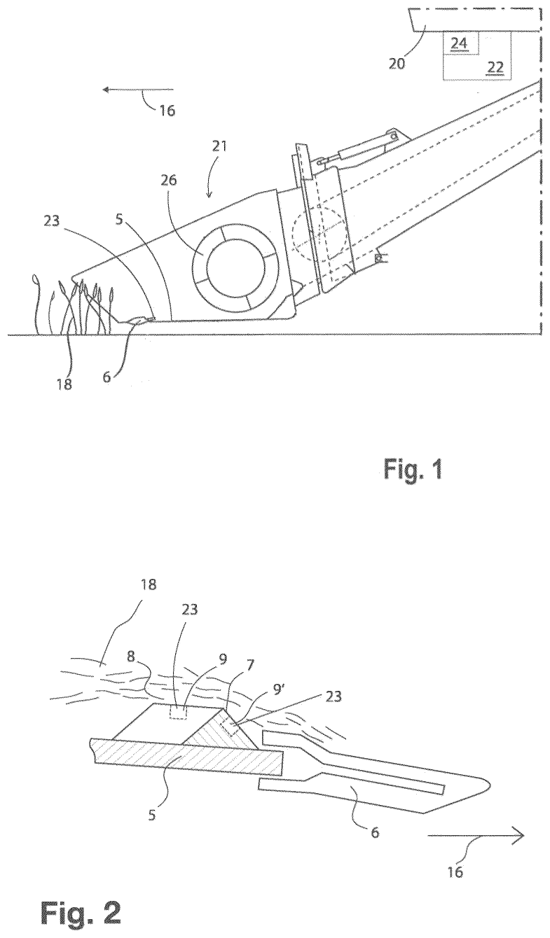

FIG. 1 shows a schematic embodiment of a harvesting machine 20 according to the invention, whereby only a part of the harvesting machine 20 is shown. A direction of travel 16 of the harvesting machine 20 is indicated by an arrow. The harvesting machine 20 has a conveyor device 21 for crop material 18 and a device 22 for monitoring a crop flow in the conveyor device 21. At least one conductivity sensor 23 is arranged on the conveyor device 21 for generating a signal representing a conductivity of a crop flow of the conveyed crop material 18. An evaluation device 24 is provided for analyzing the signal in the device 22 for monitoring the crop flow. The conveyor device 21 can be associated with a cutting device 6 of the harvesting machine 29, wherein the cutting device 6 has a cutting table 5 and wherein the at least one conductivity sensor 23 is arranged on the cutting table 5. In the illustrated embodiment example, the conveyor device 21 comprises a screw conveyor 26. Alternatively, conveyor belts (not shown) can be provided. The conductivity sensor 23 can be arranged on a restraining device 7 of the cutting table 5, which is explained in more detail with reference to FIG. 2.

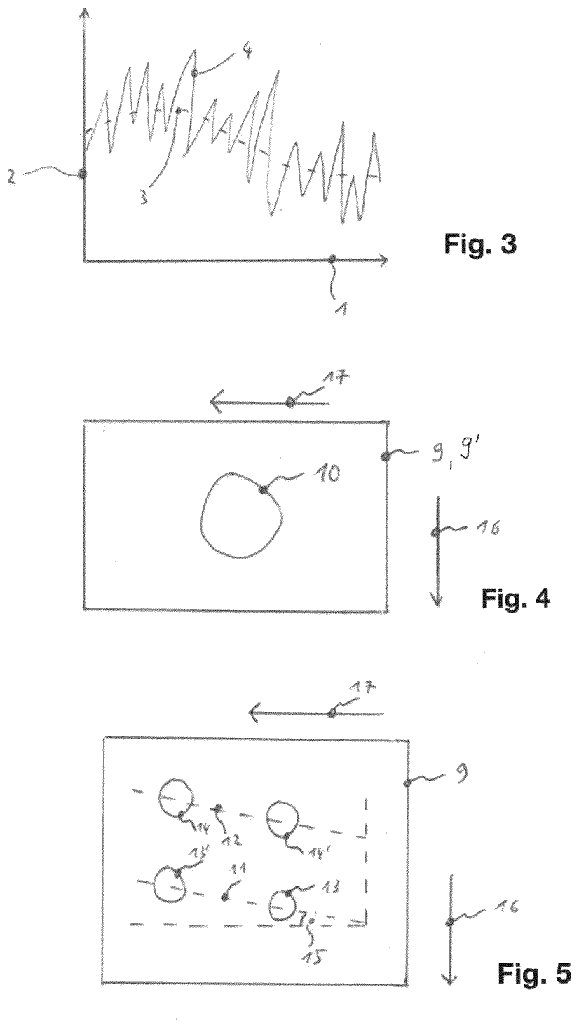

FIG. 2 shows a detail of the conveyor device 21 of the harvesting machine 20 according to FIG. 1 in a schematic sectional view. The restraining device 7 prevents the crop material 18 from falling off the cutting table 5 and has the shape of a rampart. The restraining device 7 is also referred to as the fall-back edge 7. The cross-section of the restraining device 7 shown in the illustration can be triangular, for example. The restraining device 7 can have an extension 8 parallel to a surface of the cutting table 5, whereby the conductivity sensor 23 can be arranged on the extension 8. A corresponding sensor installation space 9 on the extension 8 of the restraining device 7 is shown schematically. An alternative or additional sensor installation space 9′ can be arranged on an end face of the restraint device 7, i.e. at the front in the direction of travel 16 of the harvesting machine 20. Conventional cutting devices and Vario cutting devices generally provide both installation spaces 9 and 9′. Depending on the design, belt cutters only provide the installation space 9′, as conveyor belts run behind the drop-off edge 7. As the crop material 18 falls onto the conveyor belts, straw matting and jams on the cutting table 5 tend not to occur. This means that for these cutting devices, only the monitoring of soil displacement and crop flow blockages on the cutting system is relevant, which can be detected by the conductivity sensors 23 in the installation space 9. A plurality of conductivity sensors 23 can be arranged on the cutting table 5, wherein the conductivity sensors 23 are spaced apart from one another, wherein each of the conductivity sensors generates a signal 3, 4 (FIG. 3) representing the conductivity of the crop flow, and wherein the evaluation device 24 (FIG. 1) compares the signals 3, 4 with one another. At least some of the conductivity sensors 23 can be distributed along a width of the cutting table 5 (orthogonal to the drawing plane and the direction of travel 16). At least some of the conductivity sensors 23 can be arranged distributed along a conveying direction 17 (FIG. 4) of the crop flow through the conveyor device 21, the conveying direction 17 being orthogonal to the drawing plane and the direction of travel 16 in the case of the cutting table 5 shown. The conductivity sensors 23 are arranged on the cutting table 5 under the crop layer 18. The installation space 9 is created when the fall-back edge 7 is extended in the area of the measuring point in the direction of flow. The extension 8 creates a plane parallel to the crop layer 18, which provides the installation space 9 for the placement of the conductivity sensor 23. The parallel installation space 9, which is higher than the cutting table 5, ensures good contact with the crop material 18 in the area where the lower stalk halves fall onto the cutting table 5. In normal harvesting operation, the crop layer 18 is most homogeneous in this area. The fall-back edge 7 is located directly behind the cutting device 6. If soil is pushed over the cutting device 6, the soil must be pushed further over the fall-back edge 7 in order to reach the center of the cutting table 5. The end face of the cutting edge 7 is therefore well suited as an installation space 9′ for conductivity sensors 23, which can be used to detect accumulations of earth at an early stage. The installation space 9′ is also suitable for measuring heaps of straw, but the contact of the crop material is subject to higher scattering due to the inclined arrangement, which increases the noise component. A method for monitoring the crop flow in the conveyor device 21 for the crop material 18 is described below. An electrical conductivity of the crop flow of the conveyed crop material 18 is measured by the at least one conductivity sensor 23 in the conveyor device 21. The conductivity sensor 23 generates a signal 3, 4 that represents the measured conductivity, which is analyzed by the evaluation device 24. The crop flow is evaluated on the basis of a development of at least one of the following properties of signal 3, 4: Noise frequency, noise amplitude and base signal.

FIG. 3 shows an exemplary recorded signal of the conductivity sensor 23 in a diagram. The time is plotted on an abscissa 1, while an ordinate represents the signal curve over time. A base level 3 of the signal 3, 4 is formed from the moisture and the amount of crop material. These variables change relatively slowly. A noise component 4 of the signal 3, 4 changes relatively quickly due to the high dynamics of the sensor contact and the density of the crop material 18. Depending on how the material is positioned at the measuring point, the noise amplitude of signal 3, 4 will be higher or lower. Depending on the crop material and harvest situation, the amplitudes of the noise component 4 are significantly higher than the amplitudes of the base signal 3. It is to be expected that the speed of the change in the noise component 4 behaves in the same direction as the crop flow speed. The faster the crop layer 18 flows over one of the conductivity sensors 23, the faster the change in the noise component 4. The frequency of the noise component 4 is therefore dependent on the crop flow velocity. For example, the noise frequencies of the segments of the cutting device 6 can be compared with each other to detect disturbances in the crop flow. If the noise frequency drops in one of the segments, e.g. due to the formation of a mat of crop material 18, it can be concluded that the crop flow in this segment has stopped. If soil accumulations occur at conductivity sensors 23, the base signal 3 increases to a high degree with a simultaneous sharp reduction in the noise component 4. The reason for this is the higher density, higher water content and greater homogeneity of soil compared to straw. In this way, accumulations of soil can be detected separately from straw mats. For better comparability of the frequency changes with throughput fluctuations, the driving speed of the harvesting machine 20 can be integrated into the evaluation in addition to the comparison of the noise frequency. This makes it easier to differentiate between changes in frequency over a large part of the cutting device's 6 partial widths and large-area crop flow disturbances. Furthermore, harvesting situations occur in which the working width of the cutting device 6 is not fully utilized. In these cases, it makes sense to include the signal from a partial widths control in the evaluation. The partial widths control signal can be provided manually by the driver or by automatic systems such as GPS and optical systems.

FIGS. 4 and 5 each show diagrams to explain the conductivity measurement of the crop flow in the conveyor 21. Conductivity sensors 23 can be installed at individual or multiple measuring points within a sensor installation space 9, 9′. The sensor installation space 9, 9′ is shown schematically as a plane which is spanned by the direction of travel 16 of the harvesting machine 20 and a conveying direction 17 of the harvested crop material 18 in the conveyor device 21. FIG. 4 shows a sensor installation space 9 or 9′ with a single measuring point 10. FIG. 5 shows a sensor installation space 9 with several measuring points 13, 13′, 14, 14′. The measuring points 13 and 13′ are located on a front axis 11 viewed in the direction of travel 16. A rear axis 12 is located behind it. The axes 11, 12 can be inclined by an angle 15 relative to the conveying direction 17. On the cutting table 5, the flow of crop material 18 first enters in the direction of travel 16 and is then deflected in the conveying direction 17. Assuming that the crop layer 18 does not mix or circulate within the sensor installation space 9, the moisture measurement of the crop layer 18 at one of the measuring points 13, 13′, 14, 14′ generates a reproducible signal amplitude. If the signal amplitudes are compared over time between the measuring points 13, 13′, 14, 14′ within the sensor installation space 9, the correlations in the signal curve 3, 4 of two measuring points are offset in time depending on the deflection of the good current. Possible correlation pairings are:
Measuring point 13 as the first measuring point and measuring point 14′ as the second measuring point;
Measuring point 13′ as the first measuring point and measuring point 14 as the second measuring point;
Measuring point 13 as the first measuring point and measuring point 13′ as the second measuring point;
Measuring point 14′ as the first measuring point and measuring point 14 as the second measuring point;
Measuring point 13 as the first measuring point and measuring point 14 as the second measuring point.

The known distance and time offset of the correlating signals 3, 4 can be used to determine the crop flow velocity. This allows a more accurate and precise adjustment between fluctuations in individual sections and with the driving speed of the harvesting machine 20. Influences on the alignment of the cutting device segments, such as throughput fluctuations, are reduced.

The method can be used, for example, on an agricultural harvesting attachment, in particular on a combine harvester header. The following process steps can be carried out:
Separating the crop material 18 from the field,
Picking-up of the crop material 18 by the cutting table 5,
Redirecting the harvested crop material 18 from the direction of travel 16 in the conveying direction 17 for further conveying of the harvested crop material 18 into the harvesting machine 20,
Conveying the harvested crop material 18, wherein the conveying direction 17 can then also correspond to the direction of travel 16. The harvesting attachment is characterized in that at least two conductivity sensors 23 are fitted across the working width of the attachment, which are networked with the central evaluation device 24. The evaluation device 24 can be set up to detect irregularities and disturbances in the crop flow during the pick-up, deflection and further conveying of the crop material. The applications for monitoring the crop flow in the conveyor device 21 associated with the cutting device 5 are described here. It is additionally or alternatively possible to use the method described to monitor blockages in the harvesting machine 20. This extends the application possibilities of the sensor technology using the same hardware. For example, a conductivity sensor 23 can be arranged in a separator rotor. A further conductivity sensor 23 can be arranged downstream of the separator rotor at an inlet to a straw chopper. If crop material accumulates in the chopper, the evaluation unit detects this via the changed noise behavior of the second conductivity sensor 23. A crop flow disturbance is detected and a response can be made before the separator rotor also becomes blocked.

The conductivity sensors 23 can operate according to the principle of electrical conductivity measurement, dielectric conductivity measurement or capacitive conductivity measurement. The conductivity sensors 23 and the evaluation device 24 can be networked via analog signals or a digital bus system. The evaluation unit 24 can be arranged separately from the conductivity sensors 23 or integrated into one or more of the conductivity sensors 23.

The method can have the following steps to determine crop flow disturbances in a harvesting header:
Picking up the crop material 18;
Guiding the crop flow of crop material 18 via the conductivity sensors 23;
Generation of the conductivity signal 3, 4;
Merging at least two conductivity signals 3, 4 in the evaluation device 24;
Comparison of the signal curves 3, 4 with each other over a period of time and/or comparison of the signal curves 3, 4 with characteristic values;
Detecting of crop flow disturbances via signal comparison;
Generating and outputting of signals to indicate the crop flow disturbances by the evaluation device 24.

The output signal of the conductivity sensor 23 depends on crop density, crop moisture and contact between crop and conductivity sensor 23 as well as on density, moisture and sensor contact of foreign material soil. The material density is influenced by the amount of material and material compression. The moisture content and quantity of the crop material is subject to a relatively slow drift. The crop material contact to the conductivity sensor 23 and the density of the crop material 18 are subject to relatively rapid changes due to fluctuations in the crop layer. A noise component 4 is superimposed on the base signal 3 by these signal influences. The rate of change of the noise component 4 changes proportionally with the crop flow velocity. The comparison of at least two signals from the conductivity sensors 23 can be carried out using the rate of change of the noise component within a time period. If the rate of change of a conductivity sensor 23 drops in comparison to other conductivity sensors 23, there is a lower crop flow velocity at this measuring point. Foreign material such as earth has a higher conductivity and a more constant density. Earth at one of the conductivity sensors 23 generates a higher base signal and a lower noise component compared to the crop material. Earth accumulations at a conductivity sensor 23 can be detected by comparing the sensor signal 3, 4 with characteristic values over a period of time. The signal evaluation can include a driving speed signal, whereby a change in driving speed has a proportional effect on the rate of change of the noise component 4 and can therefore better indicate a crop flow disturbances in all sub-areas. The evaluation can also take into account a throughput-dependent signal, e.g. a cutting power, in order to compensate for influences of the stock density on the noise component 4 of the conductivity sensors 23. The evaluation can take into account a signal for the number of active sections of a multi-section cutting device, which is used to exclude sections of the cutting device that are not in the crop material from the evaluation of crop flow disturbances. The section signal can be entered manually by the machine operator or provided automatically by a GPS system or optical field monitoring. The evaluation can take into account a headland signal that indicates whether the cutting device is in the raised state, which is used to perform a zero-point calibration and thus compensate for influences due to contamination of the conductivity sensors 23. The signal values of the zero point calibration can be used to evaluate which of the cutting device sections are not in the crop and are excluded from the evaluation.

Accumulations of soil in the cutting device trough can be caused by incorrect guidance of the cutting device above the ground. Rigid cutting devices have sensing brackets for floor guidance, which detect the floor contour. The transverse tilt and height of the cutting device are adjusted using the push-buttons. If there are mounds of earth, undulations in the ground contour or furrows in the field that are not detected by the sensing brackets, soil can enter the cutting device trough through contact with the ground. Another reason for soil accumulation in the cutting device is when harvesting close to the ground with the cutting device, e.g. in stored grain. Torn plant roots and straw residues can get in front of the cutting device skids and thus push up soil. In addition, fingers or ear lifters wrapped in straw can push up the soil. The pushed-on soil passes over a straw mat into the cutting device and settles there.

Accumulations of soil in the cutting device result in poorer friction properties between the crop material and the cutting device trough. In addition, a barrier is created for the crop material. The crop material can no longer be conveyed through the cutting device and accumulates in or in front of the cutting device. No new crop material can be picked up by the cutting device at the point of blockage. As the harvesting machine moves on, further crop material is usually pressed flat and pushed under the cutting device.

The machine operator often recognizes heaps of soil relatively late. On the one hand, the soil accumulations occur under a straw mat and are not directly visible. Secondly, these usually occur on parts of the cutting device that cannot all be observed by the driver at the same time. Blockages caused by soil accumulation are often only detected when material is no longer being fed into the cutting device at the point in question. To eliminate the crop flow disturbances, the harvest must be interrupted and the material removed by hand. The later an accumulation of soil is detected, the more material has to be removed, which increases the downtime.

Crop flow disturbances can also be caused by wrapping tough straw or green growth such as burdock. The material wraps around fingers or ear lifters and blocks the path for further crop material into the knife bar or cutting device trough. As a result, further material is pushed on or pressed flat by the cutting device and fed under the cutting device. There is a possibility that after a large pile of crop material has formed, the blockage will release itself and the accumulation will be fed into the machine as a pile. If the process is repeated on the same or another section of the cutting device, the harvesting machine experiences an uneven and pulsating crop flow, which can cause blockages in the threshing units. If the blockage does not remove itself, the driver must interrupt the harvest and remove it as soon as the blockage is detected.

Uneven growing conditions in the field can cause the height of the plants and thus the straw length to vary. With conventional cutting devices or Vario cutting devices, the cutting height or table length must be adjusted to the straw length. In addition, the reel as a conveying element must also be adapted to the straw length. This ensures that the crop material falls onto the cutting table at the correct distance from the feed auger, where it is picked up by the auger and transported further. If the straw length is shorter, the crop material falls too far in front of the intake auger onto the cutting table and is not drawn in by the auger. More and more crop material collects on the cutting table and forms a straw mat. If the mat is large enough, the material is pushed to the intake auger either by the reel or by the crop material in front of the mat. The accumulation and sudden conveying of an accumulation of crop material creates an impulsive crop flow, which prevents the harvesting machine from working optimally and increases the risk of blockages in the harvesting machine. If the straw length becomes longer, the straw falls with the middle of the stalk onto the egg auger. If the crop material presses from the front, the stalk stands up on the cutting table and the crop material can form a mat. The standing stems are either pulled into the auger the wrong way round with the cut side first or fall over sideways and are bent or conveyed across the auger. This ensures an uneven crop flow. In addition, it is more difficult to thresh the crop material in the threshing drum if it is fed in the wrong way round, or the threshing units need to be adjusted differently.

### LIST OF REFERENCE SIGNS

1 Abscissa, time axis
2 Ordinate, signal strength
3 Base signal
4 Noise component of the signal
5 Cutting table
6 Cutting device
7 Restraining device, fall-back edge
8 Extension of the restraining device
9 Sensor installation space on the extension of the restraining device
9′ Sensor installation space on the front of the restraining device
10 Single measuring point
11 Front axis
12 Rear axis
13 Measuring point
13′ Measuring point
14 Measuring point
14′ Measuring point
15 Axis angle
16 Direction of travel
17 Conveying direction
18 Harvested crop material
20 Harvesting machine
21 Conveyor device
22 Device for monitoring a crop flow
23 Conductivity sensor
24 Evaluation device
26 Screw conveyor

1-15. (canceled)

16. Method for monitoring a crop flow in a conveyor device for crop material of a harvesting machine,
wherein an electrical conductivity or dielectric conductivity of the crop flow of the conveyed crop material is measured with at least one conductivity sensor in the conveyor device and a signal representing the measured conductivity is generated and wherein the signal is analyzed with an evaluation device,
wherein the crop flow is evaluated based on a development of at least one of the following characteristics of the signal: Noise frequency, noise amplitude and base signal, and
wherein a reduction in the noise frequency is interpreted as a reduced flow rate of the crop flow.

17. Method according to claim 16, wherein a reduction in the noise amplitude with a simultaneous increase in the base signal is interpreted as indicating a higher water content in the crop material flow, with, in particular, a limit value of the reduction in the noise amplitude and/or of the increase in the base signal being interpreted as indicating an accumulation of soil in the conveying device.

18. Method according to claim 16, wherein the conductivity of the crop flow of the conveyed crop material is measured with a plurality of conductivity sensors spaced apart from one another and a signal representing the measured conductivity is generated for each conductivity sensor, and the signals are analyzed with the evaluation device and compared with one another.

19. Method according to claim 18, wherein a first part of the plurality of conductivity sensors is arranged on the conveyor device and wherein a second part of the plurality of conductivity sensors is arranged on other crop material processing and/or conveying components of the harvesting machine.

20. Method according to claim 18, wherein in the event of a deviation of at least one of the properties noise frequency, noise amplitude and base signal of a first signal with respect to at least two second signals, an irregularity of the crop flow in the region of the conductivity sensor which generates the first signal is inferred.

21. Method according to claim 16, wherein at least one throughput signal characterizing a throughput of crop material through the conveyor device, such as a driving speed of the harvesting machine or a cutting power, is taken into account in the analysis of the at least one signal.

22. Method according to claim 16, wherein a conductivity of the crop flow of the conveyed crop material is measured with a multidimensional array of conductivity sensors in the conveyor device, wherein in particular a recording of a signal of the conductivity sensor at a first measuring point is compared with the respective signal of the conductivity sensor or sensors at one or more second measuring points, and wherein a direction and/or a speed of the crop flow between the first measuring point and the second measuring point is determined if the recording matches the signal of one of the second measuring points.

23. Method according to claim 22, wherein the speed of the crop flow between the first measuring point and the second measuring point is determined by relating a distance between the first measuring point and the second measuring point to a time between the recording at the first measuring point and the detection of the recording at the second measuring point.

24. Harvesting machine with a conveyor device for crop material and with a device for monitoring a crop flow in the conveyor device,
wherein at least one conductivity sensor for generating a signal representing an electrical or dielectric conductivity of a crop flow of the conveyed crop material is arranged on the conveyor device,
wherein the device for monitoring the crop flow has an evaluation device for analyzing the signal,
wherein the evaluation device evaluates the crop flow on the basis of a development of at least one of the following properties of the signal: Noise frequency, noise amplitude and base signal, and
wherein the evaluation device interprets a reduction in the noise frequency as a reduced flow rate of the crop flow.

25. Harvesting machine according to claim 24, wherein the conveyor device is assigned to a cutting device of the harvesting machine, wherein the conveyor device has a cutting table and wherein the at least one conductivity sensor is arranged on the cutting table.

26. Harvesting machine according to claim 25, wherein the conductivity sensor is arranged on a restraining device of the cutting table.

27. Harvesting machine according to claim 26, wherein the restraining device has an extension parallel to a surface of the cutting table, the conductivity sensor being arranged on the extension.

28. Harvesting machine according to claim 24, wherein a plurality of conductivity sensors is arranged on the cutting table, wherein the conductivity sensors are spaced apart from each other, wherein each of the conductivity sensors generates a respective signal representing the conductivity of the crop flow, and wherein the evaluation device compares the signals with each other.

29. Harvesting machine according to claim 18, wherein at least some of the conductivity sensors are arranged distributed along a width of the cutting table and/or wherein at least some of the conductivity sensors are arranged distributed along a conveying direction of the crop flow through the conveyor device.
